(19) United States
(12) Patent Application Publication
(10) Pub. No.: US 2019/0202603 A1
(43) Pub. Date: Jul. 4, 2019

(54) INDUSTRIAL BAG WITH A CLOSING AND OPENING SYSTEM COMPRISING A BOTTOM STRIP CAPABLE OF BEING TORN OFF AND METHOD FOR MANUFACTURING SUCH A BAG

(71) Applicant: VICAT, Vizille (FR)

(72) Inventor: Stanislas VILAIN, Vizille (FR)

(21) Appl. No.: 16/301,571

(22) PCT Filed: May 19, 2017
(86) PCT No.: PCT/FR2017/051222

§ 371 Date: Nov. 14, 2018

(30) Foreign Application Priority Data
May 20, 2016 (FR) 16 54498

(51) Int. Cl. B65D 33/16; B65D 33/00; B31B 70/26; B31B 70/62

(52) U.S. Cl. CPC B65D 33/1691; B65D 33/004; B31B 2150/003; B31B 70/62; B31B 70/261

(57) ABSTRACT

A bag for containing powdery or granular material having a tubular outer wall made of a flexible material and a closing and opening system arranged at one end of the tubular outer wall, as seen in a longitudinal direction of the bag, the closing and opening system including a pair of opposite angle folds extending longitudinally in line with the wall and folded laterally toward the interior of the bag, a pair of opposite lateral flaps extending longitudinally in line with the wall and folded transversely toward the interior of the bag, overlapping the angle folds in the longitudinal direction, where each lateral flap is attached to the two angle folds that it overlaps, the closing and opening system further including a bottom strip that is removably attached over the angle folds and the lateral flaps in the longitudinal direction, being oriented in the lateral direction so as to close the bag, where the bottom strip can be torn off entirely from the rest of the bag in order to open the bag, and includes a gripping tab which is not attached to the rest of the bag and which is located at one of the lateral ends of the bottom strip, adjacent to one of the angle folds, such that the gripping tab can be gripped and pulled in a direction away from the angle fold, so as to progressively tear off the bottom strip in the lateral direction.

### TECHNICAL FIELD

The present disclosure concerns a bag capable of containing powdery or granular matters, comprising a tubular external wall formed of a flexible material and a closing and opening system arranged at one end of the tubular external wall viewed according to a longitudinal direction of the bag.

The disclosure also relates to a method for manufacturing a bag capable of containing powdery or granular matters, comprising a phase of providing a tubular external wall formed of a flexible material and a phase of closing the tubular external wall at the level of one of its ends viewed according to a longitudinal direction of the bag.

### BACKGROUND

In the field of packaging, there are known industrial bags closed at the ends by folding and gluing and which allow storing bulk matters such as powdery or granular matters.

Conventionally, a bag of this kind comprises a tubular external wall formed of a flexible material selected to withstand the matters to be contained. Known techniques provide for the use of flexible materials generally impermeable to water vapor and comprising the stack of different layers of different kinds of materials. Some of these layers, in particular the inner and outer layers of the stack, may be formed of a paper-based material such as Kraft paper whereas intermediate layers are formed from a plastic material film, such as for example of polyethylene or polypropylene.

In order to be able to close the bag to store its content after filling and to be able to easily open the bag, it is known to equip at least one of the ends of the bag with a closing and opening system having two opposite corner folds according to a first direction and with two opposite side flaps according to a second direction. The corner folds are folded towards the inside of the volume delimited by the tubular external wall, and then the side flaps are also inwardly folded so as to overlap the corner folds previously folded. Finally, the side flaps are glued together, which ensures closure of this end of the bag. To open the bag, it is necessary to unglue the two side flaps before unfolding the side flaps first, and then the corner folds. Often, and for example in the case of a bag containing cement, opening from the bottom is so tedious that the bag is disemboweled by the user in the middle in order to extract the product.

It is also known to add a bolduc type link configured to facilitate the opening of the bag by tearing off the paper of a bottom strip along a tearing line determined by the bolduc.

While these solutions are generally satisfactory, they have nonetheless some drawbacks.

First, the quality and the resistance of the closure thus imparted may sometimes turn out to be insufficient at the time of filling and throughout the lifetime of the bag.

Besides, the manipulation of the side flaps and/or of the bolduc during the opening of the bag may sometimes be considered difficult and impractical. The operation of opening the bag sometimes becomes tedious, in particular depending on the conditions of the use of the bag or the dexterity and/or the strength of the user.

The very design of these closing systems makes impossible or very impractical any reuse of the bag subsequently to its opening, because the implementation of the opening operation tends to cause a considerable deterioration of the side flaps, of the corner folds and even of the external wall. This can also be a considerable drawback in terms of waste generation and of environmental impact. Furthermore, the pieces of paper can contaminate the matters extracted from the bag.

Moreover, the very use of bolduc and of layers formed from plastic materials has a non-negligible environmental impact for the manufacture of the bag and then for the treatment of waste and for recycling issues. Particularly, the bolduc is a contaminant to the extent that the fibers can be found in the materials extracted from the bag because of the rip generated by the tearing off of the bolduc.

Finally, the implementation of the operation of opening the bag frequently generates paper or plastic residues which may be awkward in practice for the user and which are sources of pollution risks.

Documents DE3941300A1 and DE202010010512U1 describe bags having a bottom strip configured to be ripped along perforated lines such that the bottom strip partially retracts when pulled on.

Nonetheless, in the solutions of documents DE3941300A1 and DE202010010512U1, the bottom strip is likely to be too easily ripped and opened involuntarily and inadvertently. Furthermore, these solutions require an operation consisting of the formation of the perforated lines, which is long, expensive and tedious. They also present a risk of the bottom strip being ripped in the wrong location, which is impractical and unreliable, especially depending on the conditions of use. In addition, for these solutions working, it is necessary to use a material for the bottom strip having a low resistance in order to allow it to be ripped at the level of the perforated lines: thus, for the closing system being resistant enough it is preferable to glue the side flaps together, which implies an additional operation generating additional problems of cost, complexity, and difficulty in use.

### BRIEF SUMMARY

The present disclosure aims at solving all or part of the drawbacks listed above.

In this context, there is a need to provide a bag capable of containing powdery or granular matters of the type mentioned above, which is simple, economical, reliable and user-friendly while allowing:
facilitating the implementation of the operation of opening the bag,
a possible reuse of the bag,
limiting the risks of waste generation,
limiting the problems related to the environmental impact,
offering a very good resistance at the time of filling and throughout the lifetime of the bag,
avoiding the risks of contamination of the matter extracted from the bag.

To this end, there is provided a bag capable of containing powdery or granular matters, comprising a tubular external wall formed of a flexible material and a closing and opening system arranged at one end of the tubular external wall viewed according to a longitudinal direction of the bag, said closing and opening system including:
a pair of corner folds longitudinally extending the tubular external wall at the level of said end, oppositely disposed with respect to each other in a lateral direction of the bag and laterally folded towards the inside of the bag,
a pair of side flaps longitudinally extending the tubular external wall at the level of said end, oppositely disposed with respect to each other in a transverse direction of the bag and transversely folded towards the inside of the bag and overlapping the corner folds according to the longitudinal direction, each side flap being bound to the two corner folds overlapped thereby,
and a bottom strip removably bound over the corner folds and the side flaps according to the longitudinal direction and being oriented in the lateral direction in order to ensure closure of the bag, said bottom strip being capable of being entirely torn off relative to the rest of the bag in order to open the bag and comprising a gripping tab which is not bound to the rest of the bag and located at one of the lateral ends of the bottom strip adjacently to one of the corner folds for allowing the gripping tab to be grasped and pulled in a direction going away from said corner fold in a manner ensuring a progressive tearing off of the bottom strip according to the lateral direction relative to the corner folds and to the side flaps.

According to another particular embodiment, the side flaps at least partially overlap with one another and are not bound to each other.

According to another embodiment, the side flaps have a trapezoidal shape.

According to another embodiment, the bottom strip is bound only over a portion of the total surface of the contact interface of the bottom strip with the corner folds and with the side flaps and the bottom strip is not bound to the corner folds and to the side flaps in a central portion of the bottom strip located in a median area of the bottom strip according to the lateral direction and in a median area of the bottom strip according to the transverse direction and is bound to the corner folds and to the side flaps in a peripheral portion of the bottom strip located around the central portion according to the lateral direction and according to the transverse direction.

According to another embodiment, each side flap is bound to the two corner folds overlapped thereby by an adhesive means, in particular by gluing.

According to another embodiment, the bottom strip is formed of a single-material matter and integrally made from a paper sheet or a stack of paper sheets, the bottom band having a basis weight greater than 140 g/m².

Essentially, the paper of the bottom strip is configured such that the delamination test according to the TAPPI test T 569 om-09 has a value lower than or equal to 400 J/m².

Advantageously, the bottom strip may be formed of a material free of any agent imparting internal cohesion and/or surface cohesion.

In another embodiment, the tubular sidewall is formed of a single-material matter made from a paper sheet or a stack of paper sheets.

According to another embodiment, the inner face of the bottom strip facing the corner folds and the side flaps as long as the bottom strip is not torn off includes readable indications written on the matter of the bottom strip or carries a removable self-adhesive label directly mounted on the matter of the bottom strip.

According to another embodiment, the bottom strip has opacity characteristics through its thickness such that the inner face of the bottom strip facing the corner folds and the side flaps as long as the bottom strip is not torn off and the portions of the corner folds and of the side flaps located under the bottom strip as long as the bottom strip is not torn off are invisible to the eye from outside the bag as long as the bottom strip is bound to the corner folds and to the side flaps.

According to another embodiment, the bottom strip comprises security elements authenticating the bottom strip.

It is also proposed a method for manufacturing a bag capable of containing powdery or granular matters, comprising a phase of providing a tubular external wall formed of a flexible material and a phase of closing the tubular external wall at the level of one of its ends viewed according to a longitudinal direction of the bag, the closing phase including:
a first step of forming a pair of corner folds longitudinally extending the tubular external wall at the level of said end, oppositely disposed with respect to each other in a lateral direction of the bag,
a first step of folding the corner folds laterally towards the inside of the bag,
a second step of forming a pair of side flaps longitudinally extending the tubular external wall at the level of said end, oppositely disposed with respect to each other in a transverse direction of the bag,
a second step of folding the side flaps transversely towards the inside of the bag and overlapping the corner folds according to the longitudinal direction,
a first step of binding each side flap to the two corner folds overlapped thereby,
a second step of removably binding a bottom strip over the corner folds and the side flaps according to the longitudinal direction and being oriented in the lateral direction in order to ensure closure of the bag, said bottom strip being capable of being afterwards torn off entirely relative to the rest of the bag in order to open the bag and comprising a gripping tab which is not bound to the rest of the bag during the second binding step and located at one of the lateral ends of the bottom strip adjacently to one of the corner folds to allow the gripping tab, after the second binding step, to be grasped and pulled in a direction going away from said corner fold in a manner ensuring a progressive tearing off of the bottom strip according to the lateral direction relative to the corner folds and to the side flaps in order to open the bag.

According to one embodiment of the method, during the second binding step, the bottom strip is bound only over a portion of the total surface of the contact interface of the bottom strip with the corner folds and with the side flaps, the bottom strip being in particular not bound to the corner folds and to the side flaps in a central portion of the bottom strip located in a median area of the bottom strip according to the lateral direction and in a median area of the bottom strip in the transverse direction and being bound to the corner folds and to the side flaps in a peripheral portion of the bottom strip located around the central portion according to the lateral direction and according to the transverse direction.

### BRIEF DESCRIPTION OF THE DRAWINGS

The disclosure will be better understood from the following description of particular embodiments of the disclosure given as non-limiting examples and represented in the appended drawings, in which:

FIGS. 1 to 7 represent the closing and opening system of an example of a bag according to the disclosure during the successive steps of a method for manufacturing the bag.

FIG. 8 is a perspective view of the bag after closure thereof.

### DETAILED DESCRIPTION

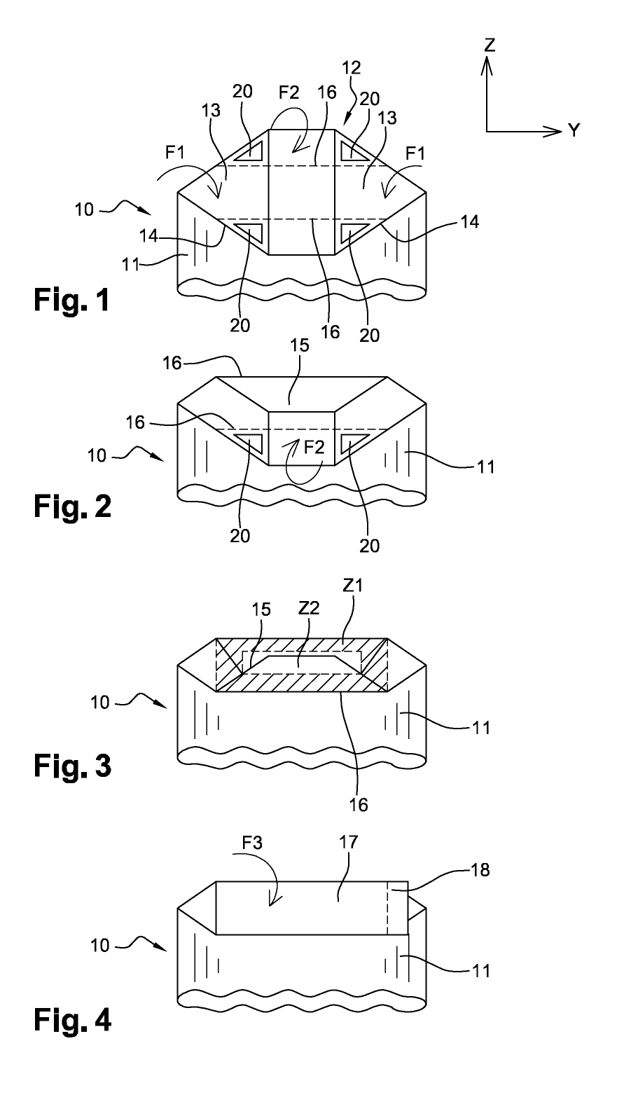

Referring to the appended FIGS. 1 to 8 as summarily presented above, the disclosure concerns a bag 10 capable of containing powdery or granular matters. The bag 10 is in particular intended for industrial applications.

The bag 10 comprises a tubular external wall 11 formed of a flexible material and at least one closing and opening system 12 of the bag 10.

In general, care is taken to choose the material in which the external wall 11 and the closing and opening system 12 are formed in order to guarantee that they both withstand the materials that the bag will contain after filling. It may optionally be searched for a water vapor impermeability function of the bag 10 in the closed state and the choice of the materials used will take this constraint into account.

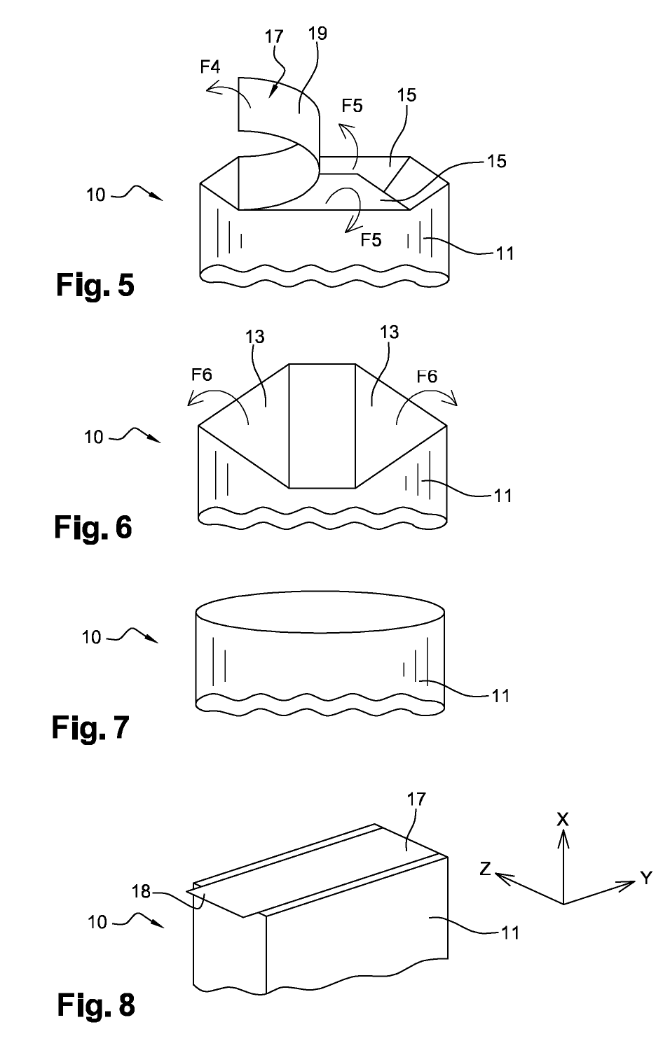

For the sake of clarity and good understanding of the description which follows, as represented in FIG. 8, an orthonormal reference frame is associated with the bag 10, with:
a longitudinal direction X of the bag 10 corresponding to the general orientation of the tubular external wall 11,
a lateral direction Y of the bag 10, generally perpendicular to the longitudinal direction X,
and a transverse direction Z of the bag 10, generally perpendicular to both the longitudinal direction X and the lateral direction Y.

The largest dimension of the bag 10, corresponding to its length, is obtained along the longitudinal direction X and the height of the external wall 11 is dimensioned accordingly. The smallest dimension of the bag 10, corresponding to its thickness, is obtained along the transverse direction Z. The intermediate dimension of the bag 10 which is comprised between its length and its thickness, corresponding to its width, is obtained along the lateral direction Y.

The disclosure also concerns a method for manufacturing a bag 10 capable of containing powdery or granular matters, comprising a phase of providing a tubular external wall 11 formed of a suitable flexible material and a phase of closing the tubular external wall 11 at the level of one of its ends viewed according to the longitudinal direction X of the bag 10. These aspects will be detailed more, particularly in connection with FIGS. 1 to 7.

The closing and opening system 12 is arranged at one end of the tubular external wall 11 viewed according to the longitudinal direction X of the bag 10. The closing and opening system 12 includes a pair of corner folds 13 extending longitudinally (that is to say according to the longitudinal direction X) the tubular external wall 11 at the level of the end where the system 12 is arranged. In other words, each of the corner folds 13 comes, before its folding, in the extension of the external wall 11 according to the longitudinal direction X. More specifically, each corner fold 13 may in particular be made in one piece with the tubular external wall 11. The corner folds 13 are oppositely disposed with respect to each other in the lateral direction Y of the bag 10 and folded laterally towards the inside of the bag 10. In other words, each corner fold 13 is folded towards the inside of the volume defined by the tubular external wall 11 along a folding line 14 oriented according to the transverse direction Z at the end of closure.

The phase of closing the bag 10 comprises a first step of forming a pair of corner folds 13 longitudinally extending the tubular external wall 11 at the level of the end where the external wall 11 is being closed during this closing phase, these folds 13 being disposed oppositely with respect to each other in the lateral direction Y of the bag 10.

The phase of closing the bag 10 comprises afterwards a first step of folding the corner folds 13 laterally towards the inside of the bag 10, that is to say according to the lateral direction Y and along a folding line 14 oriented in the transverse direction Z of the bag 10 at the end of closure. The folding movement of the corner folds 13 is represented in FIG. 1 and symbolized by the arrow F1 associated with each corner fold 13.

The closing and opening system 12 also includes a pair of side flaps 15 extending longitudinally (that is to say according to the longitudinal direction X) the tubular external wall 11 at the level of the end where the system 12 is arranged. In other words, each of the side flaps 15 comes, before its folding, in the extension of the external wall 11 according to the longitudinal direction X. More specifically, each side flap 15 may in particular be made in one piece with the tubular external wall 11. The two side flaps 15 are oppositely disposed with respect to each other in the transverse direction Z of the bag 10 and folded transversely towards the inside of the bag 10 overlapping the corner folds 13 according to the longitudinal direction X. In other words, each side flap 15 is folded towards the inside of the volume defined by the tubular external wall 11 along a folding line 16 oriented according to the lateral direction Y and overlaps each of the two corner folds 13 from above. The side flaps 15 overlap each other at least partially.

In the method for manufacturing the bag 10, the closing phase comprises a second step of forming a pair of side flaps 15 longitudinally extending the tubular external wall 11 at the level of the end where the external wall 11 is being closed during this closing phase, oppositely disposed with respect to each other in the transverse direction Z of the bag 10.

The phase of closing the bag 10 comprises afterwards a second step of folding the side flaps 15 transversely towards the inside of the bag 10, that is to say according to the transverse direction Z and along a folding line 16 oriented according to the lateral direction Y of the bag 10, overlapping the corner folds 13 according to the longitudinal direction X. The folding movement of the side flaps 15 is represented in FIGS. 2 and 3 and symbolized by the arrow F2 associated with each side flap 15 in FIGS. 1 and 2. Upon completion of this movement, at least one portion of one of the side flaps 15 overlaps at least one portion of the other side flaps 15.

Complementarily, each side flap 15 is bound to the two corner folds 13 overlapped thereby. The phase of closing the bag 10 also comprises a first step of binding each side flap 15 to the two corner folds 13 overlapped thereby. According to an advantageous embodiment, each side flap 15 is bound to the two corner folds 13 which it overlaps by an adhesive means 20 (shown in FIGS. 1 and 2), in particular by gluing.

It should be clarified that according to a particular embodiment, advantageously the side flaps 15 are not bound together. This feature will facilitate the subsequent operation of opening the bag 10 because the side flaps 15 will not need to be separated from each other unlike the prior art at the time of the operation of opening the bag 10, which furthermore, allows limiting as much as possible the generation of residues at the time of opening the bag 10. All it needs is to unfold the side flaps 15 by removing only the binding which binds them to the corner folds 13, particularly herein via the adhesive means 20.

Advantageously, the side flaps 15 have a trapezoidal shape. In other words, the lateral edges of each side flap 15 are straight, that is to say rectilinear, being devoid of cuts or any other incipient fracture.

In addition to the side flaps 15 and to the corner folds 13, the closing and opening system 12 comprises a bottom strip 17 removably bound over the corner folds 13 and the side flaps 15 according to the longitudinal direction X. The binding of the bottom strip 17 is such that after binding, it is oriented in the lateral direction Y. This bottom strip 17, which overlaps the side flaps 15 and the corner folds 13 which have all been previously folded in the previously-explained manner, allows ensuring the closure of the bag 10 at the level of the longitudinal end where the system 12 is arranged.

The bottom strip 17 is generally in the form of a rectangular sheet having a very low thickness relative to its length and its width. The notion of strip implicitly indicates that the bottom strip 17 has a length much greater than its width. Particularly, the ratio between its length and its width may be greater than or equal to 2, depending on the dimensions of the bag 10, the corner folds 13 and the side flaps 15 in the two directions Y and Z. The precision according to which the bottom strip 17 is oriented according to the lateral direction Y means that the length of the bottom strip 17 is oriented according to the lateral direction Y and that the width of the bottom strip 17 is oriented according to the transverse direction Z.

The bottom strip 17 is configured so that it can be torn off entirely relative to the rest of the bag 10 in order to open the bag 10. In other words, the bottom strip 17 is designed so that when it is torn off, it remains integral and is completely removed from the rest of the bag 10, avoiding ripping thereof. Only one portion of the binding means of the bottom strip 17 may possibly be substituted for the rest of the bag 10 after tearing off the bottom strip 17. By this faculty of the bottom strip 17, the latter is not prone to be too easily ripped and opened involuntarily and inadvertently, making it reliable and practical. It is advantageously freed from any need for an operation consisting in the formation of perforated lines, making the solution quick economical and user-friendly. In addition, the disclosure works easily even when using a material having a high resistance since the bottom strip is not intended to be ripped during its tearing off. This further avoids having to glue the side flaps together, unlike the prior art, which further avoids a supplementary operation.

The bottom strip 17 comprises a gripping tab 18 not bound to the rest of the bag 10. The gripping tab 18 is located at one of the lateral ends of the bottom strip 17. The gripping tab 18 is located adjacent at one of the corner folds 13. This arrangement allows the gripping tab 18 to be grasped and pulled in a direction away from the corner fold 13 to which it is adjacent in a manner ensuring progressive tearing off of the bottom strip 17 according the lateral direction Y relative to the corner folds 13 and to the side flaps 15.

The operation of pulling on the bottom strip 17 and its progressive lateral tearing off are symbolized by the arrow F4 in FIG. 5.

The phase of closing the bag 10 comprises a second step of removably binding a bottom strip 17 over the corner folds 13 and the side flaps 15 according to the longitudinal direction X being oriented in the lateral direction Y in order to ensure closure of the bag 10, this bottom strip 17 thus bound being capable of being then entirely torn off relative to the rest of the bag 10 in order to open the bag and comprising a gripping tab 18 which is not bound to the rest of the bag 10 during the second binding step located at one of the lateral ends of the bottom strip 17 adjacently to one of the corner folds 13 to allow the gripping tab 18, after the second binding step, to be grasped and pulled in a direction away from said corner fold 13 in a manner ensuring progressive tearing off of the bottom strip 17 according to the lateral direction Y relative to the corner folds 13 and to the side flaps 15 in order to open the bag 10.

The operation of binding the bottom strip 17 on the side flaps 15 and on the corner folds 13 is symbolized by the arrow F3 in FIG. 4. Once the bottom strip 17 is bound, the bag 10 is closed at the level of the concerned end by the closing and opening system 12 described herein. The configuration then adopted is schematically represented in FIG. 8.

The combination of folding of the corner folds 13 and the side flaps 15, of binding each side flap 15 with the two corner folds 13 overlapped thereby and of binding the bottom strip 17 as described in this document allows guaranteeing very high resistance of the closure thus obtained and ease of implementation of the opening operation.

According to one particular but non-limiting embodiment, the tubular side wall 11 is formed of a single-material matter made from a paper sheet or a stack of paper sheets. In other words, the external wall 11 is, in this particular case, advantageously formed integrally of paper. As example, the paper of which the tubular side wall 11 is formed is a Kraft paper having a basis weight comprised between 60 and 110 g/m² and may for example be unbleached or white.

Thus, the tubular external wall 11 is obtained by closing the paper sheet on itself in order to form a tubular shape. The binding area at the level of which this closure is formed, typically by gluing, extends over the entire height of the tubular external wall 11 in the longitudinal direction X but is not centered along the tubular wall 11 in the lateral direction Y. On the contrary, the closing area of the tubular wall 11 is shifted relative to the median axis thereof which is oriented along X and centered along Y, thus defining a «short side» on the side where this shift is present and a «long side» on the side opposite to the shift. The gripping tab 18 is laterally disposed on the side of the long side of the tubular external wall 11 or on the side of the short side of the tubular external wall 11.

When the user wishes to open the bag 10, he grasps the gripping tab 18 and pulls thereon in order to move it away from the corner fold 13 to which it is adjacent (Arrow F4). This causes the complete progressive lateral tearing off of the bottom strip 17. Afterwards, the side flaps 15 are unfolded (arrow F5 in FIG. 5) opposite to the folding symbolized by the arrow F2 (FIGS. 1 and 2) implemented at the time of closing the bag 10. This operation is easy because the side flaps 15 are not bound together. All it needs is to remove the binding that links the side flaps 15 to the corner folds 13. Afterwards, the corner folds 13 are unfolded (arrow F6 in FIG. 6) opposite to the folding symbolized by the arrow F1 (FIG. 1) implemented at the time of closing the bag 10. The bag 10 thus opened adopts the configuration represented in FIG. 7, known in the field as the «open mouth bag», where the corner folds 13 and the side flaps 15 are not deteriorated and are only unfolded. This avoids generating waste and allows a possible reuse of the bag 10 in order to fill it with a new content. For example, it can be used as a garbage bag or a rubble bag.

According to one particular embodiment, the bottom strip 17 is bound to the corner folds 13 and to the side flaps 15 by an adhesive means, in particular by gluing.

Preferably, the bottom strip 17 is bound only over a portion of the total surface of the contact interface of the bottom strip 17 with the corner folds 13 and with the side flaps 15. Consequently, a portion of the contact interface between the bottom strip 17 and the rest of the bag 10 is advantageously not bound, which allows facilitating the operation of tearing off the bottom strip 17 and guiding the way in which it tears off progressively when the gripping tab 18 is pulled.

In the way it is represented in FIG. 3 which is advantageous but still remains non-limiting, the bottom strip 17 is not bound to the corner folds 13 and to the side flaps 15 in a central portion Z2 of the bottom strip 17 located in a median area of the bottom strip 17 according to the lateral direction Y and in a median area of the bottom strip 17 according to the transverse direction Z. Conversely, the bottom strip 17 is bound to the corner folds 13 and to the side flaps 15 in a peripheral portion Z1 of the bottom strip 17, for example in an annular manner according to a rectangular-shaped closed contour, located around the central portion Z2 according to the lateral direction Y and according to the transverse direction Z. This arrangement very advantageously allows avoiding leakages and improving the resistance imparted by the system 12. The peripheral portion Z1 can therefore be bound via the previously mentioned adhesive means, such as by gluing, although any other binding means can be envisaged. Care is taken not to glue an external portion of the bottom strip 17 in order to preserve the gripping tab 18.

Thus, according to one particular embodiment of the method for manufacturing the bag 10, during the second binding step, the bottom strip 17 is bound only over a portion of the total surface of the contact interface of the bottom strip 17 with the corner folds 13 and with the side flaps 15, the bottom strip 17 being in particular not bound to the corner folds 13 and to the side flaps 15 in a central portion Z2 of the bottom strip 17 located in a median area of the bottom strip 17 according to the lateral direction Y and in a median area of the bottom strip 17 according to the transverse direction Z and being bound to the corner folds 13 and to the side flaps 15 in a peripheral portion Z1 of the bottom strip 17 located around the central portion Z2 according to the lateral direction Y and according to the transverse direction Z.

In general, the bottom strip 17 is formed of a material capable of withstanding the nature and the weight of the matters that the bag 10 is intended to contain. The choice of the matter of the bottom strip 17 is also guided by the requirement of the bottom strip 17 not to be ripped along its length at the moment of its tearing off: its resistance is preferably greater than the resistance of the binding between the bottom strip 17 and the rest of the bag 10, regardless of the temperature and humidity conditions. Moreover, the matter of the bottom strip 17 is adapted to avoid as much as possible that its manufacture and disposal have any environmental impact.

As a result of numerous studies and numerous tests, it has been found by the Applicant that it was very advantageous that the bottom strip 17 is formed of a single-material matter and integrally made from a paper sheet or a stack of paper sheets, the bottom strip 17 having a basis weight greater than 140 g/m². In particular, the paper used may be the paper conventionally used for the formation of joint tapes in the field of plastering.

Following numerous tests, it has been determined by the Applicant that it was very important that the paper of the bottom strip is configured such that the delamination test (conventionally called «Scott bond test») has a value lower than or equal to 400 J/m².

Advantageously, the bottom strip 17 is formed of a matter free of any agent imparting internal cohesion and/or surface cohesion.

It has also been found by the Applicant that it was very advantageous that the bottom strip 17 has the following characteristics, which may be considered individually or in combination:
a thickness comprised between 185 and 245 μm,
a porosity comprised between 600 and 1100 ml/min,
a burst index comprised between 2.5 and 4.5 kPa·m²/g,
a breaking strength viewed in the travel direction, that is to say in the direction of paper production on the manufacturing machine, comprised between 110 and 150 N/15 mm,
a breaking strength viewed in the cross direction, that is to say in the direction perpendicular to the direction of paper production on the manufacturing machine, comprised between 50 and 80 N/15 mm,
a Wet/Dry burst comprised between 35 and 65%,
a dimensional stability less than 3%.

It should be noted that the quality of the paper of which the bottom strip 17 is formed is an important point. The closing and opening system of the bag functions in particular thanks to a high resistance of the paper when binding the bottom strip 17 on the folds 13 and on the flaps 15, but especially thanks to its ability to easily defibrate by pulling when opening, without damaging the body of the bag, that is to say the external wall 11, the folds 13 and the flaps 15.

According to one particular embodiment, the inner face 19 of the bottom strip 17 facing the corner folds 13 and the side flaps 15, as long as the bottom strip 17 is not torn off, includes readable indications (not represented in the appended figures) written on the matter of the bottom strip 17 or carries a removable self-adhesive label (not represented in the appended figures) attached on the matter of the bottom strip 17. The nature of these readable indications or of the self-adhesive label may vary depending on the technical and/or commercial needs for the manufacturer and/or for the merchant and/or for the user.

According to one particular embodiment, the readable indications or the self-adhesive label bear/bears representative information of a commercial operation. The bottom strip 17, because it remains intact during its tearing off, can for example serve as a marketing support (for example a countermark) for a promotional operation. As example, the inner face 19 can be printed with a mention “won” or “lost”, or carry a self-adhesive label bearing this mention. By taking this bottom strip 17 or the self-adhesive label back to the merchant distributor, the user of the bag 10 could be given a gift in the case of presence of the mention “won”. Alternatively, a points system may be considered for customer loyalty purposes.

Preferably, in particular in the case where the bottom strip 17 bears such readable indications or a self-adhesive label, the bottom strip 17 has opacity characteristics through its thickness such that:
the inner face 19 of the bottom strip 17 facing the corner folds 13 and the side flaps 15, as long as the bottom strip 17 is not torn off, is invisible to the eye from outside the bag 10 as long as the bottom strip 17 is bound to the corner folds 13 and to the side flaps 15,
and the portions of the corner folds 13 and of the side flaps 15 located under the bottom strip 17, as long as the bottom strip 17 is not torn off, are invisible to the eye from outside the bag 10 as long as the bottom strip 17 is bound to the corner folds 13 and to the side flaps 15.

According to one particular embodiment, particularly depending on the nature of the readable indications or of the self-adhesive label carried by the inner face 19, the bottom strip 17 comprises security elements authenticating the bottom strip 17. These security elements may be obtained by the presence of visible or invisible security fibers in the mass of paper of which the bottom strip 17 is formed, by chemical security reagents, watermarks, holograms, plates, a radiofrequency micro-chip, Anti-stokes means.

The bag 10 capable of containing powdery or granular matters that has just been described, which can particularly be obtained by implementing a manufacturing method which has also been described previously, has, besides the advantages already described, the following advantages:
it facilitates the implementation of the operation of opening the bag 10, it offers the possibility of a possible reuse of the bag 10,
it has low waste generation risks,
it has a low environmental impact,
it offers very good resistance upon filling and throughout the lifetime of the bag 10.

Of course, the disclosure is not limited to the embodiments represented and described above, but it covers on the contrary all variants thereof.

1. A bag capable of containing powdery or granular matters, comprising a tubular external wall formed of a flexible material and a closing and opening system arranged at one end of the tubular external wall viewed in a longitudinal direction of the bag, said closing and opening system including:
a pair of corner folds longitudinally extending the tubular external wall at the level of said end, oppositely disposed with respect to each other in a lateral direction of the bag and laterally folded towards the inside of the bag,
a pair of side flaps longitudinally extending the tubular external wall at the level of said end, oppositely disposed with respect to each other in a transverse direction of the bag and transversely folded towards the inside of the bag and overlapping the corner folds according to the longitudinal direction, each side flap being bound to the two corner folds overlapped thereby,
and a bottom strip removably bound over the corner folds and the side flaps according to the longitudinal direction and being oriented in the lateral direction in order to ensure closure of the bag, said bottom strip being capable of being entirely torn off relative to the rest of the bag in order to open the bag and comprising a gripping tab which is not bound to the rest of the bag and located at one of the lateral ends of the bottom strip adjacently to one of the corner folds to allow the gripping tab to be grasped and pulled in a direction going away from said corner fold in a manner ensuring a progressive tearing off of the bottom strip according to the lateral direction relative to the corner folds and to the side flaps.

2. The bag according to claim 1, wherein the side flaps at least partially overlap with one another and are not bound to each other.

3. The bag according to claim 1, wherein the side flaps have a trapezoidal shape.

4. The bag according to claim 1, wherein the bottom strip is bound only over a portion of the total surface of the contact interface of the bottom strip with the corner folds and with the side flaps and in that the bottom strip is not bound to the corner folds and to the side flaps in a central portion of the bottom strip located in a median area of the bottom strip according to the lateral direction and in a median area of the bottom strip according to the transverse direction and is bound to the corner folds and to the side flaps in a peripheral portion of the bottom strip located around the central portion according to the lateral direction and according to the transverse direction.

5. The bag according to claim 1, wherein each side flap is bound to the two corner folds overlapped thereby by an adhesive means, in particular by gluing.

6. The bag according to claim 1, wherein the bottom strip is formed in a single-material matter and integrally made from a paper sheet or a stack of paper sheets, the bottom strip having a basis weight greater than 140 g/m2.

7. The bag according to claim 6, wherein the paper of the bottom strip is configured such that the delamination test according to the test TAPPI T 569 om-09 has a value lower than or equal to 400 J/m².

8. The bag according to claim 1, wherein the bottom strip is formed of a matter free of any agent imparting internal cohesion and/or surface cohesion.

9. The bag according to claim 1, wherein the tubular side wall is formed in a single-material matter made from a paper sheet or a stack of paper sheets.

10. The bag according to claim 1, wherein the inner face of the bottom strip facing the corner folds and the side flaps, as long as the bottom strip is not torn off, includes readable indications written on the matter of the bottom strip or carries a removable self-adhesive label attached on the matter of the bottom strip.

11. The bag according to claim 1, wherein the bottom strip has opacity characteristics through its thickness such that the inner face of the bottom strip facing the corner folds and the side flaps, as long as the bottom strip is not torn off, and the portions of the corner folds and side flaps located under the bottom strip, as long as the bottom strip is not torn off, are invisible to the eye from outside the bag as long as the bottom strip is bound to the corner folds and to the side flaps.

12. The bag according to claim 1, characterized in that the bottom strip comprises security elements authenticating the bottom strip.

13. A method for manufacturing a bag capable of containing powdery or granular matters, comprising a phase of providing a tubular external wall formed of a flexible material and a phase of closing the tubular external wall at the level of one of its ends viewed in a longitudinal direction of the bag, the closing phase including:
a first step of forming a pair of corner folds longitudinally extending the tubular external wall at the level of said end, oppositely disposed with respect to each other in a lateral direction of the bag,
a first step of laterally folding the corner folds towards the inside of the bag,
a second step of forming a pair of side flaps longitudinally extending the tubular external wall at the level of said end, oppositely disposed with respect to each other in a transverse direction of the bag,
a second step of transversely folding the side flaps towards the inside of the bag and overlapping the corner folds according to the longitudinal direction,
a first step of binding each side flap to both corner folds overlapped thereby,
a second step of removably binding a bottom strip over the corner folds and the side flaps according to the longitudinal direction and being oriented in the lateral direction in order to ensure closure of the bag, said bottom strip being capable of being then entirely torn off relative to the rest of the bag in order to open the bag and comprising a gripping tab which is not bound to the rest of the bag during the second binding step and located at one of the lateral ends of the bottom strip adjacently to one of the corner folds to allow the gripping tab, after the second binding step, to be grasped and pulled in a direction going away from said corner fold in a manner ensuring a progressive tearing off of the bottom strip in the lateral direction relative to the corner folds and to the side flaps in order to open the bag.

14. The manufacturing method according to claim 13, wherein during the second binding step, the bottom strip is bound only over a portion of the total surface of the contact interface of the bottom strip with the corner folds and with the side flaps, the bottom strip being in particular not bound to the corner folds and to the side flaps in a central portion of the bottom strip located in a median area of the bottom strip according to the lateral direction and in a median area of the bottom strip according to the transverse direction and being bound to the corner folds and to the side flaps in a peripheral portion of the bottom strip located around the central portion according to the lateral direction and according to the transverse direction.
